(19) United States
(12) Patent Application Publication
(10) Pub. No.: US 2007/0238518 A1
(43) Pub. Date: Oct. 11, 2007

(54) Gaming machine

(75) Inventor: Akira Osawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/730,321

(22) Filed: Mar. 30, 2007

(30) Foreign Application Priority Data
Apr. 5, 2006 (JP) JP2006-104382

(51) Int. Cl. A63F 13/00

(52) U.S. Cl. 463/20

(57) ABSTRACT

A gaming machine is provided with a display device and a processor. The display device displays cards selected from a card deck. The processor executes a card lottery providing a lottery result capable of including two or more combinations, selects destined cards from the card deck in response to the lottery result and an operation by a player, causes the display device to eventually display the destined cards, awards a payout if the destined cards include any of specific combinations, which is correspondent to said any of the specific combinations, automatically accumulates a difference between a highest payout corresponding to an optimum combination and the payout awarded by the payout awarding device as gaming values when said any of the specific combinations is different from the optimum combination corresponding to the highest payout among two or more combinations that can be realized by the lottery result and the operation of the player, and carries out a payment of the gaming values accumulated by the gaming value accumulation device.

### CROSS-REFERENCE TO RELATED APPLICATIONS

This application is based upon and claims the benefit of priority from the prior Japanese Patent Application No. 2006-104382 (filed on Apr. 5, 2006); the entire contents of which are incorporated herein by reference.

### BACKGROUND OF THE INVENTION

1. Field of the Invention

The present invention relates to a gaming machine for playing a card game.

2. Description of the Related Art

There are proposed video gaming machines to provide virtual card games for players by displaying cards on displays, and a video poker game is known as one type thereof. Japanese Patent Application Laid-open No. 2001-70642 discloses a related art of a video poker game. In the video poker, after five cards are distributed, for example, cards can be exchanged once by a selection operation of a player. Here, when a player selects cards to be left without exchanging them, that is cards to be held, remaining cards that are not to be held are turned over, and as a player presses a button, new cards after the exchange are displayed. Then, a result of the game is determined according to a combination realized by a combination of cards that are held and new cards after the exchange.

### SUMMARY OF THE INVENTION

The present invention has an object to provide a gaming machine capable of providing a card game in which an additional game may be played without impeding a smooth proceeding of the card game to offer new diversions to players.

According to a first aspect of the present invention, a gaming machine (a poker game machine 1, for example) is provided with a display device (a lower image display panel 6, for example) operable to display cards selected from a card deck; a card lottery device (a main CPU 41, S31, for example) operable to execute a card lottery providing a lottery result capable of including two or more combinations; a processor (a main CPU 41, a graphic board 68, for example) operable to select destined cards from the card deck in response to the lottery result and an operation by a player, and to cause the display device to eventually display the destined cards; a payout awarding device (a main CPU 41, S80, for example) operable to award a payout if the destined cards include any of specific combinations, the payout being corresponding to said any of the specific combinations; a gaming machine value accumulation device (a main CPU 41, S72, for example) operable to automatically accumulate a difference between a highest payout corresponding to an optimum combination and the payout awarded by the payout awarding device as gaming values when said any of the specific combinations is different from the optimum combination corresponding to the highest payout among two or more combinations that can be realized by the lottery result and the operation of the player; and a gaming value payout device (a main CPU 41, S93, for example) to pay the gaming values accumulated by the gaming value accumulation device.

Preferably, the gaming value payout device pays the gaming values if the destined cards include a special combination.

Preferably, the gaming value payout device pays the gaming values if the destined cards include specific cards.

Preferably, the gaming machine is further provided with a gaming value lottery device (a main CPU 41, S101, for example) operable to carry out a lottery regarding whether to cause the gaming value payout device to pay the gaming values or not.

According to a second aspect of the present invention, a gaming machine is provided with: a display device operable to display cards selected from a card deck; and a processor operable to execute a card lottery providing a lottery result capable of including two or more combinations, select destined cards from the card deck in response to the lottery result and an operation by a player, cause the display device to eventually display the destined cards, award a payout if the destined cards include any of specific combinations, the payout being correspondent to said any of the specific combinations, automatically accumulate a difference between a highest payout corresponding to an optimum combination and the payout awarded as gaming values when said any of the specific combinations is different from the optimum combination corresponding to the highest payout among two or more combinations that can be realized by the lottery result and the operation of the player, and carry out a payment of the accumulated gaming values.

Preferably, the processor carries out the payment if the destined cards include a special combination.

Preferably, the processor carries out the payment if the destined cards include specific cards.

Preferably, the processor is further operable to carry out a lottery regarding whether to carry out the payout or not.

According to a third aspect of the present invention, a gaming machine is provided with: a display adapted to display a plurality of cards selected from a card deck; an input device configured to receive an input of selection of cards from a player; and a processor operable to execute a card lottery of first cards to be displayed in the display and second cards to be re-displayed in the display in response to the input of the selection by the player by means of the input device, judge whether a first specific combination is realized by the first cards and the second cards to which the card lottery is executed, cause the display to display the first cards, cause the display to display a final hand by replacing the first cards with the second cards according to the input of the selection by the player, judge whether a second specific combination is realized by the final hand displayed in the display, pay out a payout correspondent to the second specific combination if the second specific combination is realized, accumulate a difference between the payout correspondent to the second specific combination and a payout correspondent to the first specific combination if the payout correspondent to the second specific combination is greater than the payout correspondent to the first specific combination, and payout the accumulated payout if a specific condition is realized, the processor being in communication with the display and the input device.

Preferably, the specific condition includes a condition in which the final hand includes a special combination.

Preferably, the specific condition includes a condition in which the final hand includes specific cards.

Preferably, the specific condition includes a determination by a lottery executed by the processor.

### BRIEF DESCRIPTION OF THE DRAWINGS

FIG. 1 is a perspective view of a poker game machine of the present embodiment;

FIG. 2 is a block diagram showing a schematic configuration of the same poker game machine;

FIG. 3 is a diagram showing one example of a standby state displayed on a lower side image display panel before a poker game is executed in the same poker game machine;

FIG. 4 is a diagram showing one example of a game content displayed on a lower side image display panel at a time of executing a poker game in the same poker game machine;

FIG. 5 is a diagram showing one example of a game content displayed on a lower side image display panel at a time of executing a poker game in the same poker game machine;

FIG. 6 is a diagram showing one example of a game content displayed on a lower side image display panel at a time of executing a poker game in the same poker game machine;

FIG. 7 is a diagram showing one example of a game content displayed on a lower side image display panel at a time of executing a poker game in the same poker game machine;

FIG. 8 is a diagram showing one example of a game content displayed on a lower side image display panel at a time of executing a poker game in the same poker game machine;

FIG. 9 is a diagram showing one example of a game content displayed on a lower side image display panel at a time of executing a poker game in the same poker game machine;

FIG. 10 is a diagram showing one example of a game content displayed on a lower side image display panel at a time of executing a poker game in the same poker game machine;

FIG. 11 is a diagram showing one example of a game content displayed on a lower side image display panel at a time of executing a poker game in the same poker game machine;

FIG. 12 is a payout table in which a number and a payout that are set to each poker combination are shown;

FIG. 13 is a flow chart of a gaming machine processing program in the same poker game machine;

FIG. 14 is a flow chart of a betting processing program in the same poker game machine;

FIG. 15 is a flow chart of a dealing processing program in the same poker game machine;

FIG. 16 is a flow chart of a drawing processing program in the same poker game machine;

FIG. 17 is a flow chart of an accumulating processing program in the same poker game machine;

FIG. 18 is a flow chart of a payout paying processing program in the same poker game machine;

FIG. 19 is a diagram showing a concrete example of types and correspondence relationships of playing cards (those to be dealt (distributed) and those that can be drawn (exchanged)) determined by an internal lottery in a unit game of this time in the same poker game machine;

FIG. 20 is a diagram showing one example of a game content displayed on a lower side image display panel at a time of executing a poker game in the same poker game machine; and

FIG. 21 is a flow chart of a mystery processing program in the same poker game machine.

### DETAILED DESCRIPTION OF THE PREFERRED EMBODIMENT

Throughout the specification, the appended drawings and claims, several terms are defined and used in accordance with the following definitions. The term “card” means not only a virtual card but also an image of a card on a display. The adjective or adverbial terms “face-up” and “face-down” with respect to the card should not be necessarily interpreted as such spatial orientations. When the card has information such as a suit and a number merely on one face thereof, the term “face-up” means showing the face having the information entirely, and the term “face-down” means hiding the face having the information entirely or partly.

An embodiment of the present invention will be described hereinafter with reference to the drawings. The following description will be given to a poker game machine as one version of a card gaming machine. For this reason, the content of the poker game to be played in the poker game machine of the present embodiment will be described briefly. The poker game machine of the present embodiment carries out a video poker by using a deck of playing cards, which carries out a draw poker in which all or some of cards in hand can be exchanged with new cards at some point in a poker game. More specifically, here, when the gaming media such as coins or the like are provided, five cards are dealt (distributed) and displayed. After that, the player holds (keeps in hand) those cards which are judged as necessary among five cards that are dealt (distributed) while drawing (exchanging) those cards which are judged as unnecessary with new cards, in order to complete any of the poker combinations (such as royal flush, straight flush, four of a kind, full house, flush, straight, three of a kind, two pairs). When the above described combination is realized, a a result, a number of coins or the like corresponding to that combination will be awarded as a payout.

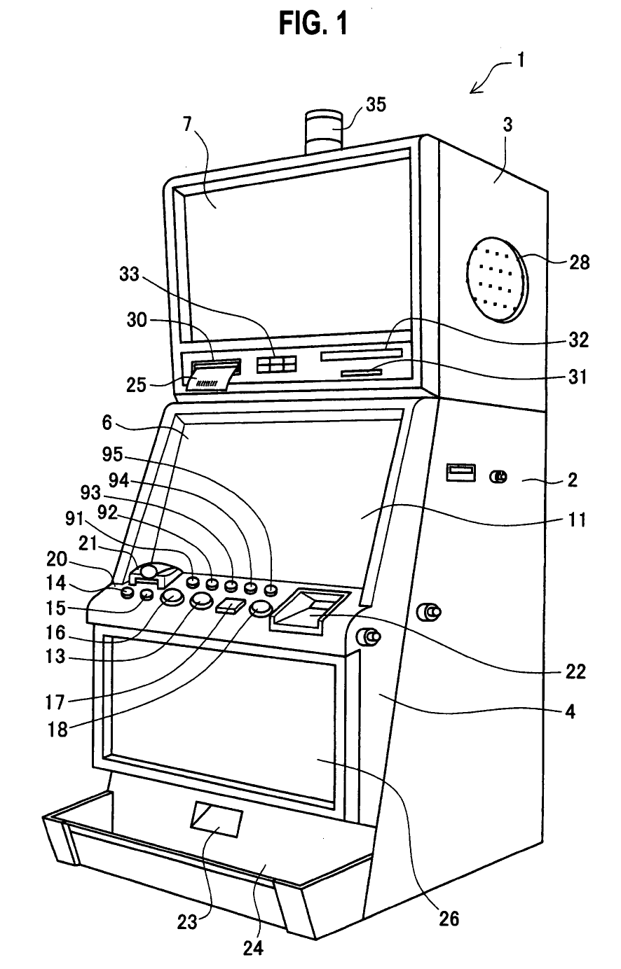

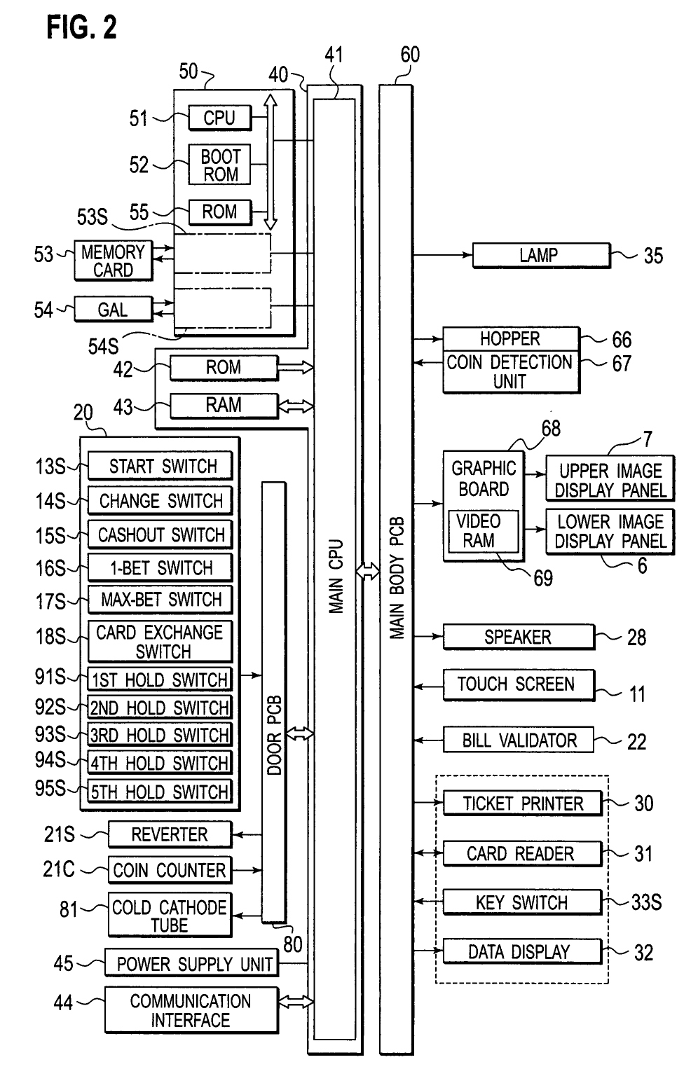

Next, the schematic configuration of the poker game machine of the present embodiment will be described according to FIG. 1 and FIG. 2. FIG. 1 is a perspective view of a poker game machine of the present embodiment. FIG. 2 is a block diagram showing a schematic configuration of the poker game machine of the present embodiment.

The poker game machine 1 of the present embodiment has a cabinet 2, a top box 3 provided on an upper side of the cabinet 2, and a main door 4 provided on a front side of the cabinet 2.

On a front side of the top box 3, an upper image display panel 7 is provided. Here, the upper image display panel 7 is formed by a known transparent liquid crystal panel, and normally displays demonstration images or information related to the game of the poker game machine 1 such as the game rules and the payout table.

On the other hand, on a front side of the main door 4, a lower image display panel 6 is provided. Here, the lower image display panel 6 is formed by a known transparent liquid crystal panel, and normally displays the game content of the video poker (the draw poker) carried out by the poker game machine 1, namely a credit amount, a bet number, dealt cards, and states of progress of the game.

Also, on a lower side of the lower image display panel 6, a control panel 20 having a plurality of buttons through which commands regarding the progress of the game will be inputted by the player arranged thereon, a coin slot 21 for receiving coins that are the gaming media into the cabinet 2, and a bill validator 22 are provided.

On the control panel 20, a start button 13, a change button 14, a CASHOUT button 15, a 1-BET button 16, a Max-BET button 17, a card exchange button 18, a first hold button 91, a second hold button 92, a third hold button 93, a fourth hold button 94, and a fifth hold button 95 are provided. The start button 13 is an operation means for inputting a command for having five cards dealt (distributed). The change button 14 is an operation means to be used at a time of requesting changes to an attendant of the gaming facility. The CASHOUT button 15 is an operation means for inputting a command for paying as many coins as the credit amount owned by the player (one credit corresponds to one coin) from a coin payout opening 23 to a coin tray 24, or for inputting a command for paying by a bar code attached ticket 25 to be described below.

The 1-BET button 16 is an operation means for accepting a command for betting one credit among the credits owned by the player to the game. The Max-BET button 17 is an operation means for accepting a command for betting maximum number of credits (40 credits in the present embodiment) that can be bet per game among the credits owned by the player to the game.

The five hold buttons 91, 92, 93, 94 and 95 are operation means for inputting a command for holding (keeping in hand) those cards which are judged as necessary among the five cards that are dealt (distributed).

The card exchange button 18 is an operation means for inputting a command for drawing (exchanging) those cards which are judged as unnecessary with new cards.

Inside the coin slot 21, a reverter 21A and a coin counter 21C are provided (see FIG. 2). Then, the reverter 21S validates whether a coin entered at the coin slot 21 is a legitimate one or not, and ejects those other than the legitimate coins from the coin payout opening 23. Also, the coin counter 21C detects the accepted legitimate coins and counts their numbers.

Also, the bill validator 22 validates whether a bill is the legitimate one or not and accepts a legitimate bill into the cabinet 2. Then, the bills entered into the cabinet 2 are converted into a number of coins, and the credits corresponding to the converted number of coins will be added as the credits owned by the player. Note that the bill validator 22 is formed to be capable of reading a bar code attached ticket 25 to be described below. On the lower front surface of the main door 4, that is on the lower part of the control panel 20, there is provided a berry glass 26 on which characters of the poker game machine 1 and the like are depicted.

Note that, in the poker game machine 1 of the present embodiment, the coins, bills or electronic values (credits) corresponding to these will be used as the game media. However, the game media that can be applied in the present invention are not limited to these, and can be medals, tokens, electronic money, or tickets, for example.

Also, on the lower side of the upper image display panel 7, a ticket printer 30, a card reader 31, a data display 32, and a key pad 33 are provided.

Here, the ticket printer 30 is a printing device that prints a bar code which encodes data such as the credit amount, the date and time, the identification number of the poker game machine 1, etc., on the ticket, and outputs it as the bar code attached ticket 25. Then, the player can make the outputted bar code attached ticket 25 read by another gaming machine to play the game on that gaming machine or use it at a time of a procedure at a prescribed location in the gaming facility.

The card reader 31 carries out reading of data from a smart card and writing of data into a smart card. The smart card is a card to be owned by the player, which stores data regarding log of games played by the player, for example.

The data display 32 comprises a fluorescent display or the like, and displays data read by the card reader 31, or data inputted by the player through the keypad 33, for example. Also, the key pad 33 is used at a time of inputting data and commands regarding the ticket issuance or the like. In addition, on a top face of the top box 3, there is provided a lamp 35. The lamp 35 is turned on by a prescribed turned on state in a case of calling up the attendant of the gaming facility or the like in a case such as when an error occurs at the poker game machine 1.

Next, a configuration related to a control system of the poker game machine 1 of the present embodiment will be described according to FIG. 2.

As shown in FIG. 2, the control system of the poker game machine 1 basically comprises a mother board 40 and a gaming board 50.

Describing the gaming board 50 first, the gaming board 50 has a CPU 51, a ROM 55 and a boot ROM 52 which are mutually connected through an internal bus, a card slot 53S corresponding to a memory card 53, and an IC socket 54S corresponding to a GAL (Generic Array Logic) 54.

The memory card 53 is formed by a non-volatile memory, which is a recording medium for recording a game program and a game system program (which will be referred to as a game program and the like in the following). The game program recorded in the memory card 53 includes a lottery program. This lottery program is a program for determining five cards to be dealt (distributed) and displayed and five cards that can be displayed anew as they are drawn (exchanged). Then, the lottery program contains symbol weighing data respectively corresponding to plural types of payout rates (80%, 84%, 88%, for example).

Also, the payout rate is determined according to the payout rate setting data outputted from the GAL 54. The lottery is carried out according to the symbol weighing data corresponding to this payout rate.

Also, the card slot 53S is formed such that the memory card 53 can be inserted or extracted, and connected to the mother board 40 through the IDE bus. Consequently, by rewriting the game program or the like stored in the memory card 53, it is possible to change a type and a content of the game to be played on the poker game machine 1. Also, by exchanging it with the memory card 53 that stores another game program or the like, it is also possible to change a type and a content of the game to be played on the poker game machine 1.

Note that the game program includes a program related to the game progress, image data and sound data to be outputted during the game, as well as image data of the game rules, the payout table and the like, and the demonstration images.

The GAL 54 is a kind of PLD having an OR fixed type array structure. The GAL 54 has a plurality of input ports and output ports, and when prescribed data are inputted into the input ports, data corresponding to these data are outputted from the output ports. The data outputted from the output ports are the payout rate setting data mentioned above.

Also, the IC socket 54S is formed such that the GAL 54 can be attached or detached, and connected to the mother board 40 through the PCI bus. Consequently, by rewriting the GAL 54 or exchanging the GAL 54 itself, it is possible to change the payout rate setting data to be outputted from the GAL 54.

The CPU 51, the ROM 55 and the boot ROM 52 that are mutually connected through the internal bus are connected to the mother board 40 through the PCI bus. The PCI bus carries out the signal transmission between the mother board 40 and the gaming board 509, as well as the power supply from the mother board 40 to the gaming board 50. The ROM 55 stores a country identification information and an authentication program. The boot ROM 52 stores a spare authentication program and a program (boot codes) for the CPU 51 to activate the spare authentication program.

The authentication program is a program (alteration checking program) for authenticating the game program and the like. The authentication program is described along a procedure for carrying out the alteration checking of the game program and the like which is a target of the authentication reading processing. The spare authentication program is a program for authenticating the above described authentication program, which is described along a procedure for carrying out the alteration checking of the authentication program that is a target of the authentication processing.

Next, the mother board 40 will be described. The mother board 40 is formed by using a commercially available general purpose mother board (a printed wiring board that implements base components of a personal computer) and has a main CPU 41, a ROM 42, a RAM 43, and a communication interface 44.

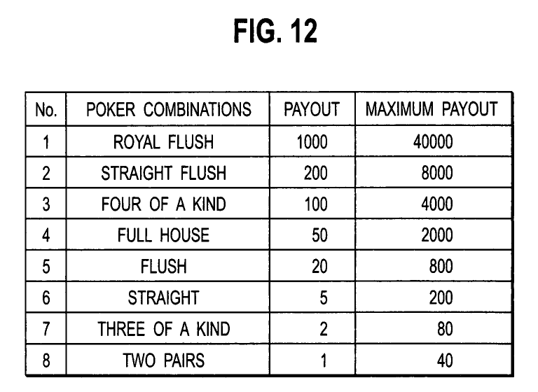

The ROM 42 is formed by a memory device such as a flash memory, and stores programs such as BIOS to be executed by the main CPU 41 and data to be used permanently such as the payout table (see FIG. 12). When the BIOS is executed by the main CPU 41, the processing for initializing prescribed peripheral devices is carried out and the processing for reading the game program and the like stored in the memory card 53 through the gaming board 50 is started.

The RAM 43 stores data and programs to be used when the main CPU 41 is operated. Also, the RAM 43 can store various programs such as the authentication program, the game program and the like that are read out through the gaming board 50, and various information such as the credit amount currently owned by the player and the like.

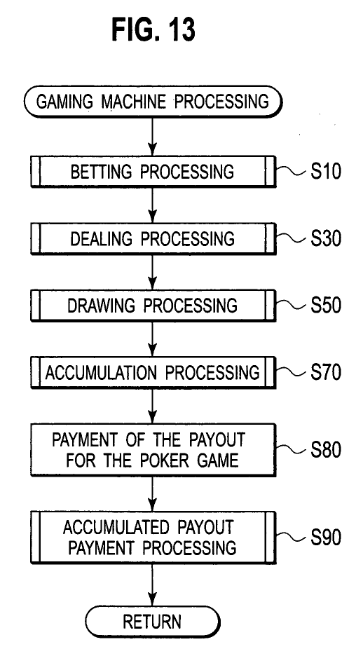

Also, the communication interface 44 is a communication device for carrying out communications with the server or the like that is provided inside the gaming facility through a communication channel. The poker game machine 1 communicates the betting information in the gaming machine processing (see FIG. 13) to be described below, the internal lottery result of the dealing processing and the like, with the server or the like through the communication interface 44.

Also, to the Mother board 40, a main body PCB 60 and a door PCB 80 to be described below are connected through the respective USB. In addition, a power source unit 45 is connected to the mother board 40. When the power is supplied from the power source unit 45 to the mother board 40, the main CPU 41 of the mother board 40 is activated. In addition, the power is supplied to the gaming board 50 through the PCI bus and the CPU 51 is activated.

To the main body PCB 60 and the door PCB 80, devices for generating input signals to be inputted into the main CPU 41 and devices whose operations are to be controlled by control signals from the main CPU 41 are connected. The main CPU 41 executes the game program and the like stored in the RAM 43 according to the input signals inputted into the main CPU 41. Then, the main CPU 41 carries out the prescribed calculation processing, stores the calculation results into the RAM 43, and carries out the control processing with respect to each device.

To the main body PCB 60, a lamp 35, a hopper 66, a coin detection unit 67, a graphic board 68, a speaker 28 (see FIG. 1), a touch screen 11, a bill validator 22, a ticket printer 30, a card reader 31, a key switch 33S, and a data display 32 are connected.

Here, the touch screen 11 is arranged on a front face of the lower image display panel 6, and capable of identifying a coordinate position of a portion touched by the player and where the player touched and which direction the touch portion has moved according to the identified coordinate position information.

The hopper 66 is provided inside the cabinet 2, and pays the prescribed number of coins according to the control signal from the main CPU 41, from a coin payout opening 23 to a coin tray 24. The coin detection unit 67 is provided inside the coin payout opening 23, and outputs an input signal with respect to the main CPU 41 when it is detected that the prescribed number of coins are paid from the coin payout opening 23.

The graphic board 68 controls the image display on the upper image display panel 7 and the lower image display panel 6 according to the control signal from the main CPU 41.

Here, the graphic board 68 has a VDP (Video Display Processor) for generating image data according to the control signal from the main CPU 41 and a video RAM 69 for temporarily storing the image data generated by the VDP. Note that the image data to be used at a time of generating the image data by the VDP are contained in the game program.

Also, the bill validator 22 validates whether the bill or the bar code attached ticket 25 is legitimate or not, and accepts the legitimate bill or bar code attached ticket 25 into the cabinet 2. The bill validator 22 outputs an input signal with respect to the main CPU 41 according to the amount of that bill when the legitimate bill is accepted. Also, it outputs an input signal with respect to the main CPU 41 according to the number of coins recorded in the legitimate bar code attached ticket 25.

The ticket printer 30 prints the bar code which encodes data such as the credit amount stored in the RAM 43 and the like, on the ticket, according to the control signal outputted from the main CPU 41, and outputs it as the bar code attached ticket 25.

Also, the card reader 31 reads data from the smart card and transmit it to the main CPU 41, or writes data into the smart card according to the control signal outputted from the main CPU 41. The key switch 33S is provided on the key pad 38, and outputs a prescribed input signal to the main CPU 41 when the key pad 38 is operated by the player. The data display 32 displays the data read by the card reader 31 or the data inputted by the player through the key pad 33, according to the control signal outputted from the main CPU 41.

On the other hand, to the door PCB 80, a control panel 20, a reverter 21S, a coin counter 21C and a cold cathode tube 81 are connected. On the control panel 20, a start switch 13S corresponding to a start button 13, a change switch 14S corresponding to a change button 14, a CASHOUT switch 15S corresponding to a CASHOUT button 15, a 1-BET switch 16S corresponding to a 1-BET button 16, a Max-BET switch 17S corresponding to a Max-BET button 17, a card exchange switch 18S corresponding to a card exchange button 18, a first hold switch 91S corresponding to a first hold button 91, a second hold switch 92S corresponding to a second hold button 92, a third hold switch 93S corresponding to a third hold button 93, a fourth hold switch 94S corresponding to a fourth hold button 94, and a fifth hold switch 95S corresponding to a fifth hold button 95 are provided. Each switch outputs an input signal with respect to the main CPU 41 when the corresponding button is operated by the player.

The coin counter 21C is provided inside the coin slot 21, and validates whether coins entered at the coin slot 21 are legitimate ones or not. Those coins that are not the legitimate ones will be ejected from the coin payout opening 23, and it outputs an input signal with respect to the main CPU 41 when the legitimate coins are detected.

The reverter 21S is operated according to a control signal outputted from the main CPU 41, to distribute the coins recognized as the legitimate coins by the coin counter 21C to the cash box (not shown) provided inside the poker game machine 1 or the hopper 66. The cold cathode tube 81 is provided on the back side of the lower image display panel 6 and the upper image display panel 7, and it functions as the back light as it is turned on according to a control signal from the main CPU 41.

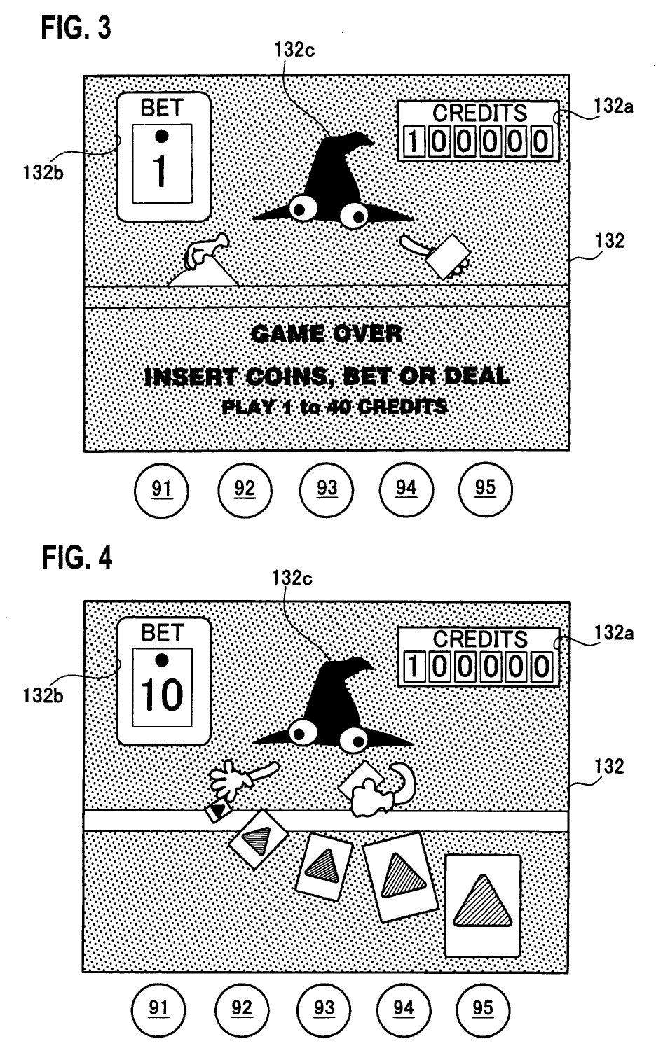

Next, the concrete example of the gaming procedure in the poker game machine 1 of the present embodiment will be described with references to FIG. 3 to FIG. 11.

FIG. 3 is a diagram showing one example of a display screen 132 of the lower image display panel 6 in the standby state, before the poker game is executed (which will be referred hereafter simply as “display screen 132). Also, FIG. 4 to FIG. 11 are diagrams showing examples of a game content displayed on the display screen 132 at a time of executing a poker game.

First, the terminologies regarding the cards will be described. “Suite” refers to a mark on a card, which comes in four types of Spade, Heart, Diamond and Club.

Also, a “pattern” refers to a type of card that is determined by a combination of the suite and the number on a card, which includes an Ace of Heart, a King of Spade, etc.

Also, a “number” refers to the number on the card, which comes in thirteen types of A (Ace, corresponding to 1), 2, 3, 4, 5, 6, 7, 8, 9, 10, J (Jack, corresponding to 11), Q (Queen, corresponding to 12), and K (King, corresponding to 13).

In addition, a “symbol” refers to all these including “suite”, “pattern” and “number”.

Then, in the poker game machine 1 of the present embodiment, as shown in FIG. 3, when coins are entered into the coin slot 21 or the bills are entered into the bill validator 22 or the coins or the like are given as the payout in the case where the display screen 132 is a title screen in the standby state, it becomes a state in which there are some credits in a memory region secured in the RAM 43, so that the credit amount is displayed in a credit amount display area 132a on an upper right corner of the display screen 132. For example, as shown in FIG. 3, in the case where the credit amount is “100000”, the letters “100000” will be displayed in the credit amount display area 132a on an upper right corner of the display screen 132. In this state, when the 1-BET button 16 is pressed, one is added to the bet number in the memory region secured in the RAM 43 whenever the button is pressed. Also, when the Max-BET button 17 is pressed, the bet number in the memory region secured in the RAM 43 becomes “40” as it is pressed. Then, if the bet number is greater than or equal to “1”, it is possible to execute the draw poker. In addition, at this point, the current bet number will be displayed in the bet number display area 132b on an upper left cornet of the display screen 132. For example, in the case where the bet number is “1”, the letter “1” will be displayed in the bet number display area 132b on an upper left corner of the display screen 132 as shown in FIG. 3, and in the case where the bet number is “10”, the letter “10” will be displayed in the bet number display area 132b on an upper left corner of the display screen 132 as shown in FIG. 4 to FIG. 11.

Note that, in the poker game machine 1 of the present embodiment, a character 132c who is a dealer for distributing the cards (which will be referred to as a “dealer 132c” in the following) will be displayed on a center of the display screen 132, as shown in FIG. 3 to FIG. 11, while the poker game is executed.

Here, the poker combinations will be described. The “poker combinations” are manners by which a part or all of five cards coincide according to certain rules in the draw poker, and here they specifically include two pairs, three of a kind, straight, flush, full house, four of a kind, straight flush, and royal flush (see FIG. 12). In this regard, the two pairs is a manner of having two sets in which the numbers on two cards coincide. Also, the three of a kind is a manner of having one set in which the numbers on three cards coincide. Also, the straight is a manner of having five cards with consecutive numbers in an order of A, 2, . . . , 10, J, Q, K, A, without requiring the coincidence of the suites. Also, the flush is a manner in which all five cards have the coinciding suite. Also, the full house is a manner of having one set in which the numbers on two cards coincide and one set in which the numbers on three cards coincide. Also, the four of a kind is a manner of having one set in which the numbers on four cards coincide. Also, the straight flush is a manner that is both the straight and the flush. Also, the royal flush is a manner that is both the straight and the flush and the numbers on cards are consecutive in an order of 10, J, Q, K, A.

Then, as shown in FIG. 12, the number and the payout are set to each poker combination. FIG. 12 is a payout table which shows the number and the payout that are set to each poker combination.

First, the number set to each poker combination will be described.

As shown in the payout table of FIG. 12, the number “No. 8” is assigned to the poker combination of the two pairs. Also, the number “No. 7” is assigned to the poker combination of the three of a kind. Also, the number “No. 6” is assigned to the poker combination of the straight. Also, the number “No. 5” is assigned to the poker combination of the flush. Also, the number “No. 4” is assigned to the poker combination of the full house. Also, the number “No. 3” is assigned to the poker combination of the four of a kind. Also, the number “No. 2” is assigned to the poker combination of the straight flush. Also, the number “No. 1” is assigned to the poker combination of the royal flush.

Next, the payout set to each poker combination will be described.

As shown in the payout table of FIG. 12, when the poker combination of the two pairs is realized, one coin will be given for the bet number “1”. Consequently, in the case of the maximum bet number “40”, 40 coins will be given as the maximum payout. Also, when the poker combination of the three of a kind is realized, two coins will be given for the bet number “1”. Consequently, in the case of the maximum bet number “40”, 80 coins will be given as the maximum payout. Also, when the poker combination of the straight is realized, five coins will be given for the bet number “1”. Consequently, in the case of the maximum bet number “40”, 200 coins will be given as the maximum payout.

Also, when the poker combination of the flush is realized, twenty coins will be given for the bet number “1”. Consequently, in the case of the maximum bet number “40”, 800 coins will be given as the maximum payout. Also, when the poker combination of the full house is realized, fifty coins will be given for the bet number “1”. Consequently, in the case of the maximum bet number “40”, 2000 coins will be given as the maximum payout. Also, when the poker combination of the four of a kind is realized, one hundred coins will be given for the bet number “1”. Consequently, in the case of the maximum bet number “40”, 4000 coins will be given as the maximum payout. Also, when the poker combination of the straight flush is realized, two hundred coins will be given for the bet number “1”. Consequently, in the case of the maximum bet number “40”, 8000 coins will be given as the maximum payout. Also, when the poker combination of the royal flush is realized, one thousand coins will be given for the bet number “1”. Consequently, in the case of the maximum bet number “40”, 40000 coins will be given as the maximum payout.

Note that the payout table shown in FIG. 12 is stored in the ROM 42 as described above, and in addition all combinations of the cards for each poker combination are also stored.

### <Dealing of the Poker>

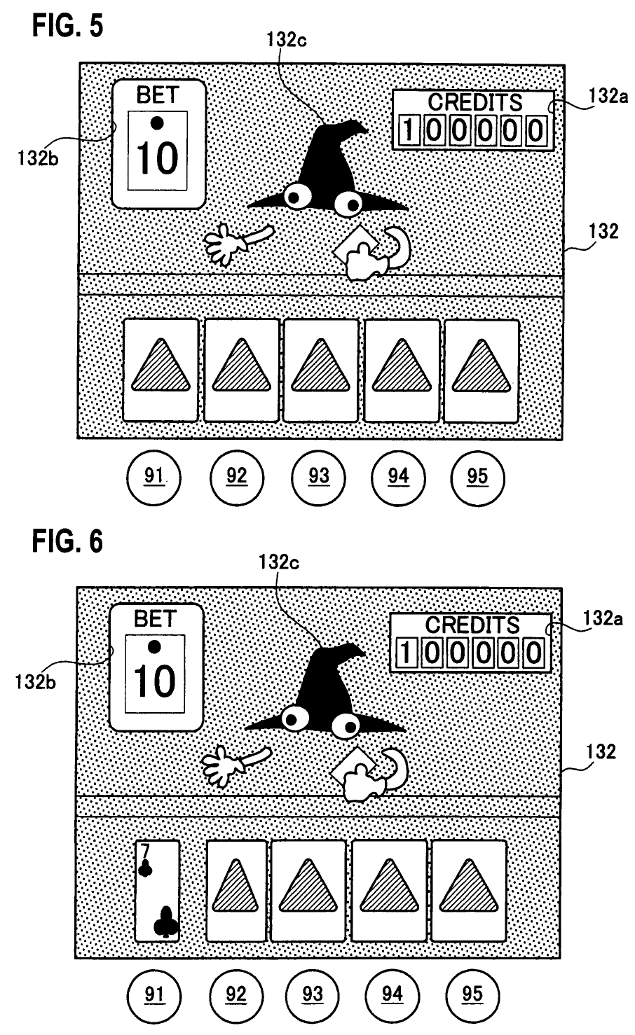

After that, when the start button 13 is pressed, five cards will be dealt (distributed) according to the internal lottery based on random numbers generated by a lottery program which reflects the payout rate. At this point, five cards to be drawn (exchanged) are also determined. At this point, on the display screen 132, five cards that are dealt (distributed) are first displayed as covered cards that are laid face down, as shown in the display screen 132 of FIG. 4 and FIG. 5.

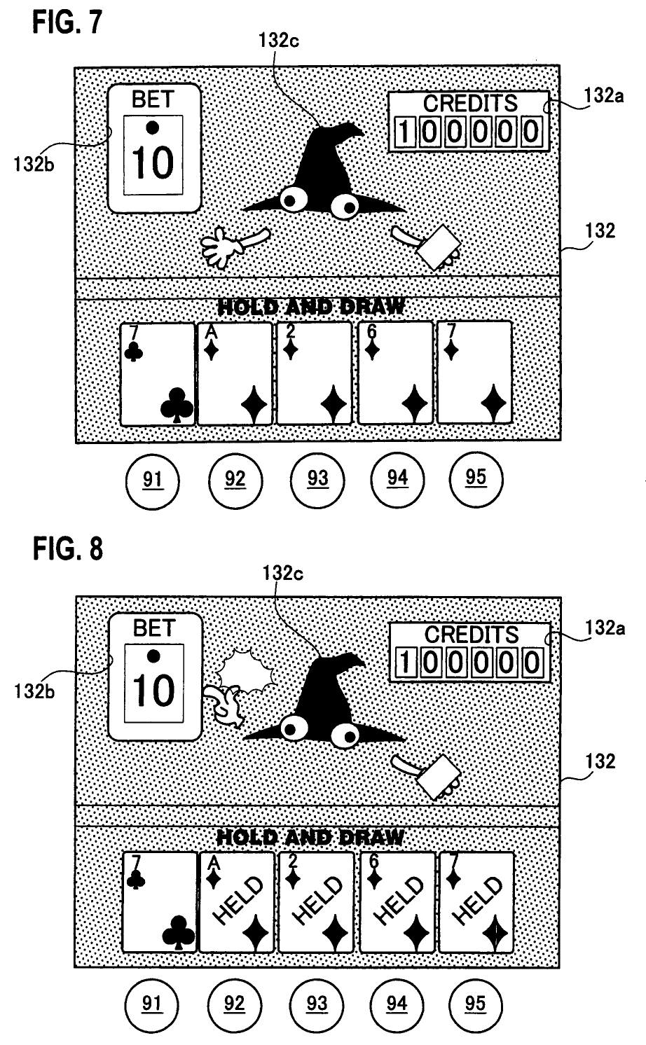

Then, at the display screen 132, five cards that are laid face down will be displayed as being turned over to be laid face up sequentially from the left side, as shown in the display screen 132 of FIG. 6 and FIG. 7.

### <Drawing of the Poker>

After that, at the display screen 132, the letters “HOLD AND DRAW” will be displayed as shown in the display screen 132 of FIG. 7, for example, and the player selects the cards to be held (kept in hand) among five cards that are turned over to be laid face up. For this selection, the hold buttons 91, 92, 93, 94 and 95 (see FIG. 1) that are respectively located directly below the cards will be used. Note that, in FIG. 3 to FIG. 11, the hold buttons 91, 92, 93, 94 and 95 are depicted below the display screen 132 in order to clarify the positional relationships of the cards displayed on a lower central portion of the display screen 132 and the hold buttons 91, 92, 93, 94 and 95.

Consequently, at this point, in the case of holding the card of “7 of Club” that is located at the leftmost end in the display screen 132 shown in FIG. 7, the hold button 91 that is located directly below that card of “7 of Club” will be pressed. Also, in the case of holding the card of “A (1) of Diamond” that is located second from the left end, the hold button 92 that is located directly below that card of “A (1) of Diamond” will be pressed. Also, in the case of holding the card of “2 of Diamond” that is located third from the right end, the hold button 93 that is located directly below that card of “2 of Diamond” will be pressed. Also, in the case of holding the card of “6 of Diamond” that is located second from the right end, the hold button 94 that is located directly below that card of “6 of Diamond” will be pressed. Also, in the case of holding the card of “7 of Diamond” that is located at the rightmost end, the hold button 95 that is located directly below that card of “7 of Diamond” will be pressed.

Then, at this point, when the hold button 91 is pressed, the letters “HELD” for indicating that this card is held will be displayed in superposition to the card of “7 of Club” that is located at the leftmost end as displayed at the display screen 132. Also, when the hold button 92 is pressed, the letters “HELD” for indicating that this card is held will be displayed in superposition to the card of “A (1) of Diamond” that is located second from the left end as displayed at the display screen 132. Also, when the hold button 93 is pressed, the letters “HELD” for indicating that this card is held will be displayed in superposition to the card of “2 of Diamond” that is located third from the right end as displayed at the display screen 132. Also, when the hold button 94 is pressed, the letters “HELD” for indicating that this card is held will be displayed in superposition to the card of “6 of Diamond” that is located second from the right end as displayed at the display screen 132. Also, when the hold button 95 is pressed, the letters “HELD” for indicating that this card is held will be displayed in superposition to the card of “7 of Diamond” that is located at the rightmost end as displayed at the display screen 132.

Note that, in FIG. 8, for the sake of explanation, it is assumed that upon seeing the combination (corresponding to the “distribution state”) of the cards “7 of Club”, “A (1) of Diamond”, “2 of Diamond”, “6 of Diamond” and “7 of Diamond”, the player decided to hold four cards of “A (1) of Diamond”, “2 of Diamond”, “6 of Diamond” and “7 of Diamond” in an attempt to realize the flush and pressed the hold buttons 92, 93, 94 and 95. As a result, at the display screen 132, as shown in FIG. 8, the letters “HELD” for indicating that this card is held are displayed in superposition to the card of “A (1) of Diamond” that is located second from the left end as displayed at the display screen 132, the letters “HELD” for indicating that this card is held are displayed in superposition to the card of “2 of Diamond” that is located third from the right end as displayed at the display screen 132, the letters “HELD” for indicating that this card is held are displayed in superposition to the card of “6 of Diamond” that is located second from the right end as displayed at the display screen 132, and the letters “HELD” for indicating that this card is held are displayed in superposition to the card of “7 of Diamond” that is located at the rightmost end as displayed at the display screen 132.

Note that when the player selects the cards to be held (kept in hand), it is also possible to use the touch screen 11 that is arranged on a front face of the lower image display panel 6 (the display screen 132) instead of the hold buttons 91, 92, 93, 94 and 95. In this case, the cards to be held (kept in hand) among five cards displayed at the display screen 132 are selected as the player touches them through the touch screen 11.

Then, when the selection of the cards to be held is finished, the card exchange button 18 is pressed.

Note that, at this point, in the case of not holding any card, the card exchange button 18 will be pressed without pressing any of the hold buttons 91, 92, 93, 94 and 95.

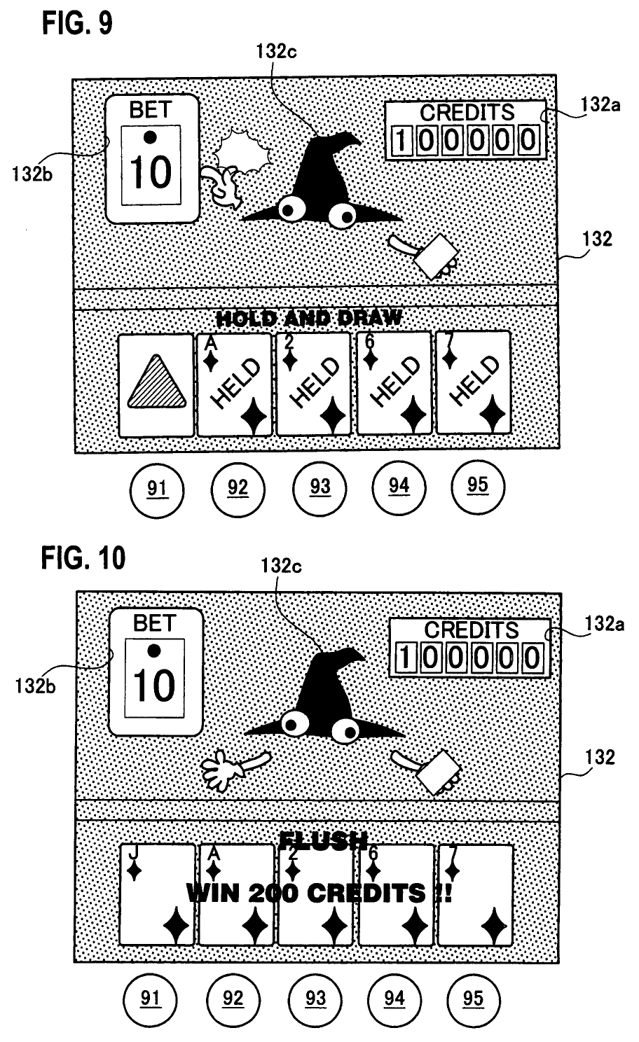

After that, the draw (exchange) for the cards that are not selected for hold will be carried out. At this point, at the display screen 132, the drawn (exchanged) cards are first displayed as covered cards that are laid face down, as shown in the display screen 132 of FIG. 9.

Note that the cards to be drawn (exchanged) are already determined by the internal lottery when five cards are dealt (distributed) as described above, and this point will be described below.

In addition, the drawn (exchanged) cards that are laid face down will be displayed as being turned over to be laid face up.

Then, at the display screen 132, after the drawn (exchanged) cards that are laid face down are turned over to be laid face up, if any of the poker combinations is realized by five cards of the player including the drawn (exchanged) cards and the held cards (which are displayed with the letters “HELD” in superposition in a state in which they are revealed), the name of that poker combination and its payout will be displayed. For example, as shown in the display screen 132 of FIG. 10, the letters “FLUSH” and “WIN 200 CREDITS!!” will be displayed in superposition to five cards of the player.

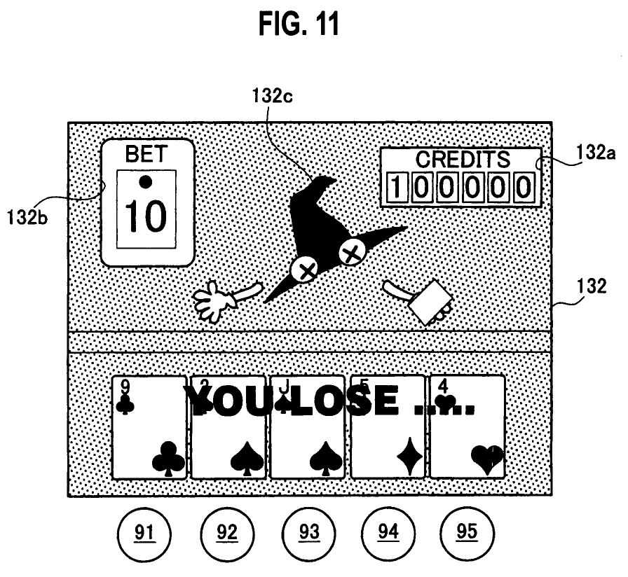

On the other hand, if none of the poker combinations is realized by five cards of the player including the drawn (exchanged) cards and the held cards (which are displayed with the letters “HELD” in superposition in a state in which they are revealed), the fact that it is game over is displayed at the display screen 132, and it is returned to the title screen in the standby state. For example, after the letters “YOU LOSE . . . are displayed in superposition to five cards as shown in the display screen 132 of FIG. 11, it is returned to the title screen in the standby state as shown in the display screen 132 of FIG. 3.

Next, the control operation of the poker game in the poker game machine 1 of the present embodiment will be described according to FIG. 13 to FIG. 18. FIG. 13 to FIG. 18 are flow charts showing the game control operation. Note that programs shown below by the flow charts of FIG. 13 to FIG. 18 are stored in the ROM 42 and the RAM 43 provided in the poker game machine 1, and executed by the main CPU 41.

In the poker game machine 1, it is assumed that the memory card 53 is inserted into the card slot 53S and the GAL 54 is attached to the IC socket 54S on the gaming board 50. Then, when the power switch is turned on at the power source unit 45 (the power is turned on), the mother board 40 and the gaming board 50 are respectively activated, and the mother board 40 and the gaming board 50 carry out respectively separate authentication processings in parallel.

Namely, on the gaming board 50, a CPU 51 reads out a spare authentication program stored in a boot ROM 52, and carries out a spare authentication for checking and verifying that an authentication program is not altered in advance, before it is taken into the mother board 40, according to that read out spare authentication program.

On the other hand, on the mother board 40, a main CPU 41 executes a BIOS stored in a ROM 42, develops compressed data incorporated into the BIOS on a RAM 43, executes the BIOS developed on the RAM 43, and carries out a diagnosis and an initialization of various peripheral devices.

After that, the main CPU 41 reads out an authentication program stored in a ROM 55 and carries out an authentication for checking and verifying that the game program and the like stored in the memory card 53 that is inserted into the card slot 53S are not altered. When this authentication processing is finished normally, the main CPU 41 stores the authentication target (authenticated) game program and the like into the RAM 43, and acquires a payout rate setting data and a country identification information.

After carrying out the above described processing, the main CPU 41 terminates the authentication processing.

Then, the main CPU 41 sequentially reads out and executes the game program and the like that are authenticated by the authentication processing from the RAM 43, and carries out the gaming machine processing shown in FIG. 13. By executing this gaming machine processing, the poker game at the poker game machine 1 of the present embodiment will be executed. Then, this gaming machine processing is repeatedly executed while the power is supplied to the poker game machine 1.

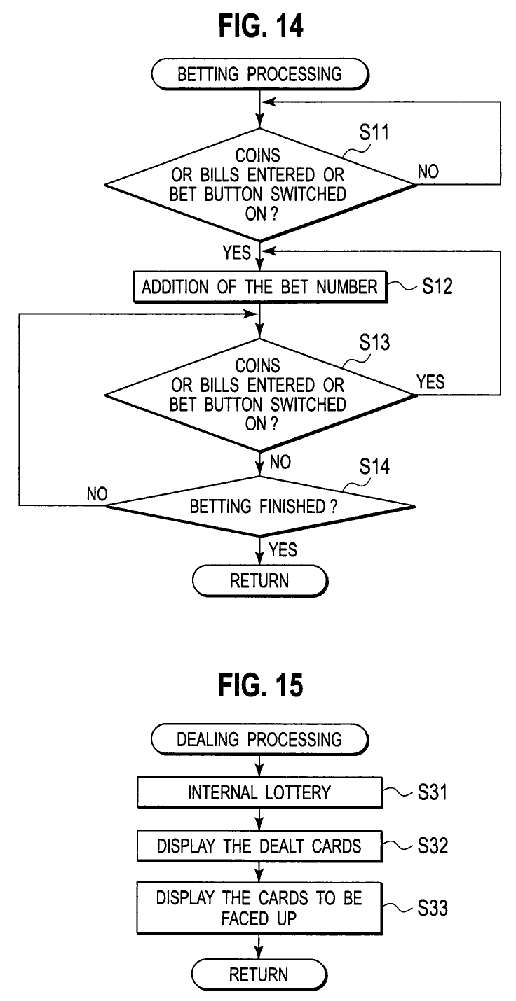

Namely, in the poker game machine 1 of the present embodiment, the gaming machine processing of FIG. 13 is executed, and the betting processing of FIG. 14 is carried out at the step (which will be abbreviated as “S” in the following) 10 first.

Now, turning to explain the betting processing of FIG. 14, whether or not either coins or bills are entered or the 1-BET button 16 or the Max-BET button 17 is pressed is judged at S11 first, and it will wait until either coins or bills are entered or the 1-BET button 16 or the Max-BET button 17 is pressed (S11: NO). This judgment is made by receiving the input signal from the 1-BET switch 16S or the Max-BET switch 17S due to the pressing of the 1-BET button 16 or the Max-BET button 17 at the main CPU 41, or by receiving the input signal from the coin slot 21 or the bill validator 22 at the main CPU 41. Then, when it is judged that either coins or bills are entered or the 1-BET button 16 or the Max-BET button 17 is pressed (S11: YES), it proceeds to S12.

At S12, the addition of the bet number is carried out, and after adding “1” to the bet number in the memory region secured in the RAM 43, it proceeds to S13.

At S13, whether or not either coins or bills are entered or the 1-BET button 16 or the Max-BET button 17 is pressed is judged again. This judgment is also made by receiving the input signal from the 1-BET switch 16S or the Max-BET switch 17S due to the pressing of the 1-BET button 16 or the Max-BET button 17 at the main CPU 41, or by receiving the input signal from the coin slot 21 or the bill validator 22 at the main CPU 41. At this point, when it is judged that either coins or bills are entered or the 1-BET button 16 or the Max-BET button 17 is pressed (S13: YES), it returns to S12 and the processing described above is repeated. On the other hand, when it is judged that neither coins or bills are entered nor the 1-BET button 16 or the Max-BET button 17 is pressed (S13: NO), it proceeds to S14.

At S14, whether or not the operation to enter coins or bills or press the 1-BET button 16 or the Max-BET button 17 is finished is judged. This judgment is made by receiving the input signal from the start switch 13S due to the pressing of the start button 13 at the main CPU 41. At this point, when it is judged that the operation to enter coins or bills or press the 1-BET button 16 or the Max-BET button 17 is not finished (S14: NO), it returns to S13 and the processing described above is repeated. On the other hand, when it is judged that the operation to enter coins or bills or press the 1-BET button 16 or the Max-BET button 17 is finished (S14: YES), the bet number is ascertained and it returns to the gaming machine processing of FIG. 13, and the dealing processing of FIG. 15 is carries out at S30.

Now, turning to explain the dealing processing of FIG. 15, the internal lottery processing regarding the cards to be dealt is carried out at S31 first. In this processing, the main CPU 41 carries out the sampling of random numbers by this lottery program. The sampled random numbers are stored in the RAM 43 as random numbers indicating the lottery result, and the main CPU 41 determines types and correspondence relationships of the cards corresponding to these random numbers (those to be dealt (distributed) and those that can be drawn (exchanged)) by referring to the lottery table stored in the memory card 53. Then, after storing data regarding the types and the correspondence relationships of these cards into the RAM 43, it proceeds to S32.

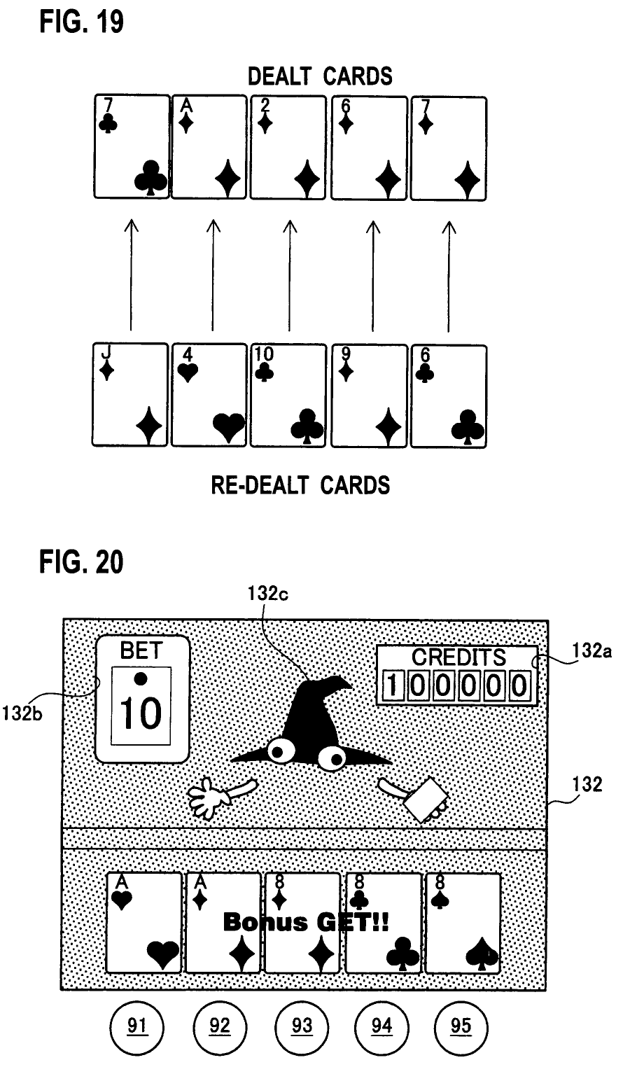

Here, the concrete example of the determination content at the above described S31 will be described according to FIG. 19. The result of the internal lottery processing is such as, in the concrete example of FIG. 19, for example, the cards to be dealt (distributed) are determined as “7 of Club”, “A (1) of Diamond”, “2 of Diamond”, “6 of Diamond” and “7 of Diamond” and the cards that can be drawn (exchanged) are determined as “J (11) of Diamond”, “4 of Heart”, “10 of Club”, “9 of Diamond”, and “6 of Club”.

In addition, here for the sake of explanation, the correspondence relationships between the cards to be dealt (distributed) and the cards that can be drawn (exchanged) is determined at the same time. For example, in the concrete example of FIG. 19, in the case where the dealt (distributed) card “7 of Club” is not to be held (kept in hand), the card to be drawn (exchanged) instead of that is “J (11) of Diamond”, and likewise in the case where the dealt (distributed) card “A (1) of Diamond”, “2 of Diamond”, “6 of Diamond”, or “7 of Diamond” is not to be held (kept in hand), the card to be drawn (exchanged) instead of that is “4 of Heart”, “10 of Club”, “9 of Diamond”, or “6 of Club”, respectively.

In this way, the cards to be dealt (distributed) and the cards that can be drawn (exchanged) as well as their correspondence relationships are determined at the same time by the internal lottery processing, so that the poker combinations that can be realized by the unit game of this time are also ascertained at this point. For example, in the concrete example of FIG. 19, in the case where the dealt (distributed) cards “A (1) of Diamond”, “2 of Diamond”, “6 of Diamond” and “7 of Diamond” are held (kept in hand), the card “7 of Club” that is excluded from the hold (not kept in hand) will be drawn (exchanged) with “J (11) of Diamond”, so that the flush (for the suite of Diamond) having the payout of giving 20 coins for the bet number “1” will be realized. Also, in the case where the dealt (distributed) card “6 of Diamond” is held (kept in hand) and the dealt (distributed) card “7 of Diamond” is excluded from the hold (not kept in hand), the card “7 of Diamond” that is excluded from the hold (not kept in hand) will be drawn (exchanged) with “6 of Club”, so that the two pairs (for “6 of Diamond” and “6 of Club”) having the payout of giving one coin for the bet number “1” will be realized.

Consequently, there is a relationship of difference in amount between the payouts of the poker combinations that can be realized in the unit game of this time, and here the poker combination having the highest payout among the poker combinations that can be realized in the unit game of this time is set as the optimum combination in the unit game of this time. Then, this optimum combination is set as a target of the payout rate.

Note that data regarding the poker combinations that can be realized in the unit game of this time, the payouts corresponding to them and the poker combination that is going to be the optimum combination are stored in the RAM 43 as realized combination related data.

Note that even if there is no correspondence relationship between the cards that are dealt (distributed) and the cards that can be drawn (exchanged) when they are determined by the internal lottery processing, the above described optimum combination will be determined when the result of the internal lottery processing is obtained, just as in the case where cards to be drawn (exchanged) are chosen randomly from “J (11) of Diamond”, “4 of Heart”, “10 of Club”, “9 of Diamond” and “6 of Club” after a part of all of the dealt (distributed) cards “7 of Club”, “A (1) of Diamond”, “2 of Diamond”, “6 of Diamond” and “7 of Diamond” are excluded from the hold (not kept in hand).

Next, at S32, the main CPU 41 transmits the display command to the graphic board 68, and the graphic board 68 which received that command distributes and displays five cards that are target of dealing (distributing) in a state of being laid face down at the display screen 132 (see FIG. 4 and FIG. 5). Then, also at S33, the main CPU 41 transmits the display command to the graphic board 68, and the graphic board 68 which received that command displays five cards as being turned over to be laid face up sequentially from the left end at the display screen 132 (see FIG. 6). At this point, the symbols on the front faces of five cards are made to coincide with those of the data regarding the types of the cards that are target of dealing (distributing) which are stored in the RAM 43 at S32 described above.

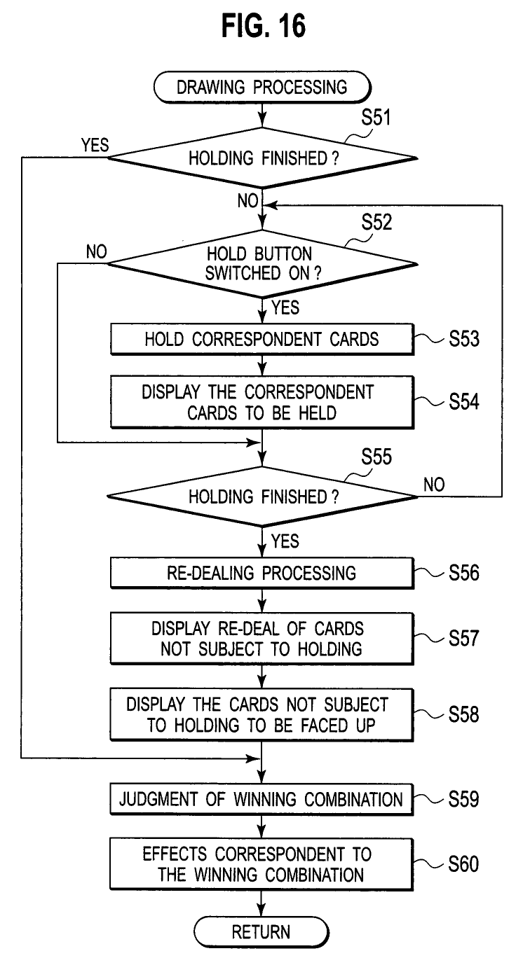

After that, it returns to the gaming machine processing of FIG. 13, and the drawing processing of FIG. 16 is carried out at S50.

Now, turning to explain the drawing processing of FIG. 16, whether the holding operation is finished or not is judged. This judgment is made by receiving the input signal from the card exchange switch 18S due to the pressing of the card exchange button 18 at the main CPU 41. Also, at the same time, the main CPU 41 transmits the display command to the graphic board 68, and the graphic board 68 which received that command displays the letters “HOLD AND DRAW” at the display screen 132 (see FIG. 7). Then, when the main CPU 41 does not receive the input signal from the card exchange switch 18S even after a prescribed time has elapsed since the letters “HOLD AND DRAW” are displayed at the display screen 132, it is judged that the holding operation is finished (S51: NO) and it proceeds to S52.

At S52, whether the hold button 91, 92, 93, 94 or 95 is pressed or not is judged. This judgment is made by receiving the input signal from the hold switch 91S, 92S, 93S, 94S or 95S due to the pressing of the hold button 91, 92, 93, 94 or 95 at the main CPU 41. At this point, when it is judged that the hold button 91, 92, 93, 94 or 95 is pressed (S52: YES), it proceeds to S53.

Note that the operation to press each of the hold buttons 91, 92, 93, 94 and 95 is allowed once per unit game.

At S53, the cards that correspond to those of the hold buttons 91, 92, 93, 94 and 95 that are judged as pressed at S52 described above are held (kept in hand). More specifically, the main CPU 41 determines the cards to be held according to the input signals from the hold switches 91S, 92S, 93S, 94S and 95S due to the pressing of the hold buttons 91, 92, 93, 94 and 95, stores data regarding the distributed locations of these cards into the RAM 43, and proceeds to S54.

At S54, the main CPU 41 transmits the display command to the graphic board 68, and the graphic board 68 which received that command displays the letters “HELD” in superposition to the held cards at the display screen 132 (see FIG. 8). At this point, the held cards are made to coincide with those of the data regarding the distributed locations of the cards which are stored in the RAM 43 at S53 described above.

After that, it proceeds to S55, and whether the holding operation is finished or not is judged. This judgment is made by receiving the input signal from the card exchange switch 18S due to the pressing of the card exchange button 18 at the main CPU 41. At this point, when it is judged that the holding operation is not finished (S55: NO), it returns to S52 and the processing described above is repeated. On the other hand, when it is judged that the holding operation is finished (S55: YES), it proceeds to S56.

At S56, the re-dealing processing is carried out. In this processing, the main CPU 41 reads out the types of the cards to be drawn (exchanged) instead of the cards that are excluded from the hold (not kept in hand), according to the data regarding the types and the correspondence relationships of the cards (see FIG. 19) which are stored in the RAM 43 by the determination of S31 described above, and stores data regarding the types of the cards to be drawn (exchanged) and the cards to be held (kept in hand) into the RAM 43. After that, it proceeds to S57.

At S57, the main CPU 41 transmits the display command to the graphic board 68, and the graphic board 68 which received that command distributes and displays the cards that are target of drawing in a state of being laid face down at the display screen 132 (see FIG. 9). Then, also at S58, the main CPU 41 transmits the display command to the graphic board 68, and the graphic board 68 which received that command displays the cards that are target of drawing as being turned over to be laid face up at the display screen 132 (see FIG. 10). At this point, the symbols on the front faces of the cards that are target of drawing are made to coincide with those of the data regarding the types of the cards which are stored in the RAM 43 at S56 described above.

After that, it proceeds to S59, and the judgment of the winning combination is made. Also, when the main CPU 41 receives the input signal from the card exchange switch 18S within a prescribed time since the letters “HOLD AND DRAW” are displayed at the display screen 132 at S51 described above, it is regarded that the holding is not to be carried out at all and it is judged that the holding operation is finished (S51: YES), and it proceeds to S59 in this case as well and the judgment of the winning combination is made. Then, at the judgment of S59, the main CPU 41 judges whether a combination of the symbols of five cards displayed at the display screen 132 corresponds to any poker combination or a lost one, according to the data regarding the types of the cards which are stored in the RAM 43 at S56 described above and the judgment table stored in the memory card 53.

After that, it proceeds to S60, and the main CPU 41 transmits the display command according to the winning combination or a lost one to the graphic board 68, and the graphic board 68 which received that command displays the letters “FLUSH” and “WIN 200 CREDITS!!” in superposition to five cards (see FIG. 10), or displays the letters “YOU LOSE . . . ” in superposition to five cards (see FIG. 11), at the display screen 132, for example.

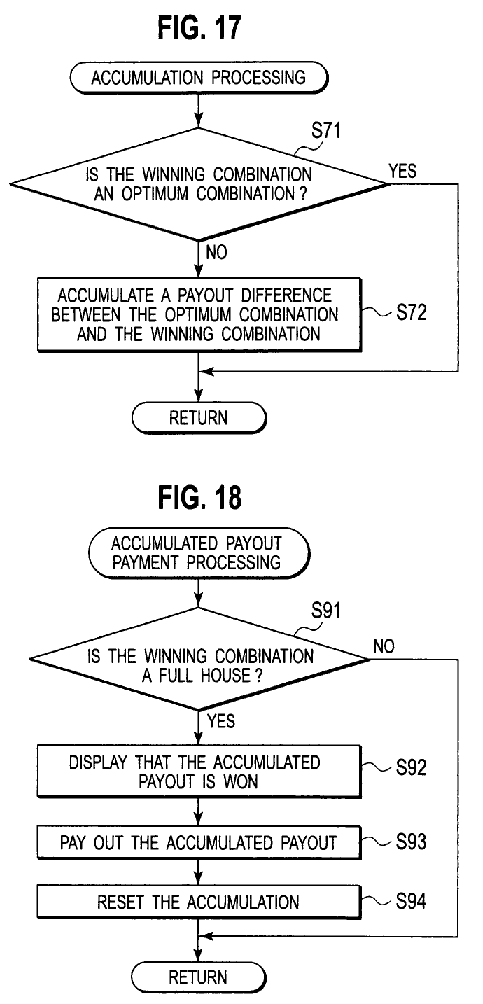

After that, it returns to the gaming machine processing of FIG. 13, and the accumulation processing of FIG. 17 is carried out at S70.

Now, turning to explain the accumulation processing of FIG. 17, whether the winning combination is the optimum combination or not is judged at S71 first. This judgment is made by the main CPU 41 according to the realized combination related data which are stored in the RAM 43 by S31 described above. Here, when it is judged that the winning combination is not the optimum combination (S71: NO), it proceeds to S72, and the main CPU 41 calculates a difference between the payout of the optimum combination and the payout of the winning combination and stores that payout difference into the RAM 43. At this point, if the payout difference already exists (not equal to “0”) in the RAM 43, it is added to the already existing payout difference and stored in the RAM 43.

After that, including the case where it is judged that the winning combination is the optimum combination (S71: YES), it returns to the gaming machine processing of FIG. 13, and it proceeds to S80.

Here, the accumulation processing of FIG. 17 described above will be described by using the concrete example of FIG. 19. In the concrete example of FIG. 19, the flush (for suite of Diamond) which has the payout for giving 20 coins per the bet number “1” and the two pairs (for “6 of Diamond” and “6 of Club”) which has the payout for giving one coin per the bet number “1” have possibilities of being realized in the unit game of this time, and the flush (for suite of Diamond) is the optimum combination in the unit game of this time, so that the payout difference becomes “0” when the winning combination is the flush (for suite of Diamond) and the payout difference becomes “19” when the winning combination is the two pairs (for “6 of Diamond” and “6 of Club”). Note that when the bet number is greater than or equal to “2”, the payout difference “19” will be multiplied by the bet number.

Then, when it returns to the gaming machine processing of FIG. 13 and S80 is executed, the payment of the payout for the winning combination is made. More specifically, values as much as the number of coins corresponding to the payout of the winning combination that is realized in the unit game of this time are added and stored as the credits in the RAM 43. At this point, the main CPU 41 transmits the display command to the graphic board 68, and the graphic board 68 which received that command changes the credit amount in the credit amount display area 132a on an upper right corner of the display screen 132.

After that, the accumulated payout payment processing of FIG. 18 is carried out at S90.

Now, turning to explain the accumulated payout payment processing of FIG. 18, whether the winning combination is the full house or not is judged at S91 first. In this judgment, similarly as in S59 described above, the main CPU 41 judges whether a combination of the symbols of five cards displayed at the display screen 132 corresponds to the poker combination of the full house or not, according to the data regarding the types of the cards which are stored in the RAM 43 at S56 described above and the judgment table stored in the memory card 53. Here, when it is judged that the winning combination is the full house (S91: YES), it proceeds to S92, and the main CPU 41 transmits the display command to the graphic board 68, and the graphic board 68 which received that command displays the letters “BONUS GET! !” at the display screen 132, as shown in FIG. 20, for example, so as to display the fact that the accumulated payout is won. After that, when S93 is executed, the payment of the accumulated payout is made. More specifically, values as much as the number of coins corresponding to the payout difference which is added and stored in the RAM 43 by S72 described above are added and stored as the credits in the RAM 43. At this point, the main CPU 41 transmits the display command to the graphic board 68, and the graphic board 68 which received that command changes the credit amount in the credit amount display area 132a on an upper right corner of the display screen 132. After that, when S94 is executed, the main CPU 41 resets the payout difference stored in the RAM 43 to “0”.

Note that the judgment criterion of S91 described above is not limited to the full house, and it may be the other poker combination or the like.

After that, it returns to the gaming machine processing of FIG. 13, and the gaming machine processing of FIG. 13 is carried out repeatedly, as described above.

As described in detail above, in the poker game machine 1 of the present embodiment, the draw poker is played by using one set of playing cards. In this regard, the cards to be dealt (distributed) are determined by the internal lottery processing (S31), and the cards to be held (kept in hand) are determined by the pressing operation of the hold buttons 91, 92, 93, 94 and 95 by the player (S53). Then, the drawing (exchange) is carried out for the cards which are excluded from the hold selection (S56-58). After that, if any of the poker combinations is realized by five cards of the player including the cards that are drawn (exchanged) and the cards that are held (kept in hand), the payout corresponding to that realized combination will be given (S80).

At that point, in the internal lottery processing (S31), the cards that can be drawn (exchanged) are also determined in addition to the cards to be dealt (distributed) (see FIG. 19). Consequently, when the internal lottery processing (S31) is carried out, the poker combinations that can be realized in the unit game of this time are ascertained, and the optimum combination for which the highest payout will be awarded among these poker combinations that can be realized is also ascertained. For this reason, every time a unit game in which the actually realized winning combination (the realized combination among the poker combinations) for which a payout is awarded and the optimum combination are different is carried out (S71: NO), a payout difference between the optimum combination and the winning combination (the realized combination among the poker combinations) is accumulated (S72), and these accumulated payout differences are paid (S93) when it is a unit game in which the actually realized winning combination (the realized combination among the poker combinations) for which a payout is awarded is the full house (S91: YES).

In this way, the additional game for awarding the payout difference described above is carried out without obstructing a smooth proceeding of the draw poker, so that it is possible to increase interests of players with respect to the draw poker.

Also, the optimum combination determined by the internal lottery processing (S31) is set to be the target of the payout rate, so that even when the accumulated payout difference is paid (S93), there is no need to carry out the control for adjusting the payout rate that is set with respect to the internal lottery processing (S31), and also the payout rate, as expected will be maintained, so that there will be no loss to the one who is providing the poker game machine 1.

Also, in the video poker such as the draw poker carried out by the poker game machine 1 of the present embodiment, it is possible to acquire the gaming skills for obtaining high payouts after a certain amount of gaming experiences are accumulated, so that it is also possible for the player who acquired such gaming skills to enjoy the additional game for awarding the payout difference as means for obtaining high payouts.

Also, if the obstruction of a smooth proceeding of the draw poker is not taken into consideration, it is possible to increase the opportunities for having the payout difference awarded more than the progressive bonus, by handling the additional game for awarding the payout difference in a manner of the bonus game.

Note that the present invention is not limited to the embodiment described above, and can be modified in various ways within a range of not deviating from its essence.

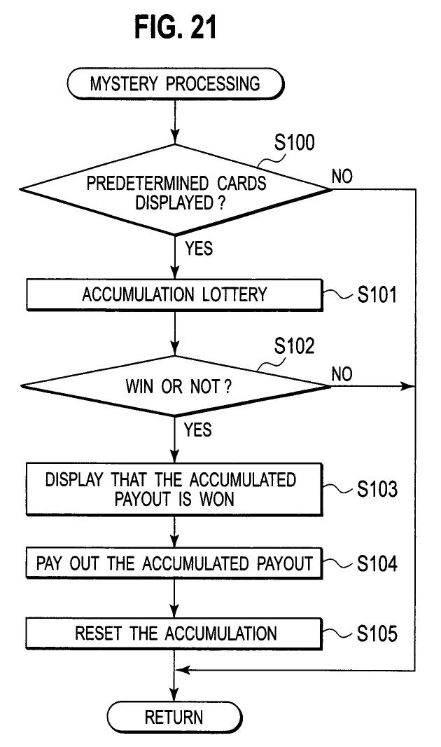

For example, at S90 of FIG. 13, it is possible to carry out a mystery processing of FIG. 21 instead of the accumulated payout payment processing of FIG. 18. Now, turning to explain the mystery processing of FIG. 21, the main CPU 41 judges whether a card of a prescribed symbol is displayed at the display screen 132 or not at S100 first, according to the data regarding the types of the cards which are stored in the RAM 43 by S56 described above. In this regard, the prescribed symbol can “A (1) of Heart”, for example. Here, when it is judged that a card of a prescribed symbol is displayed at the display screen 132 (S100: YES), it proceeds to S101, and the main CPU 41 carries out an accumulation lottery. This accumulation lottery is carried out by extracting one random number in a prescribed range by the present program. After that, it proceeds to S102, and the main CPU 41 judges whether it is winning or not. This judgment is made according to the judgment table that is set in advance in the memory card 53 and the random number extracted at S101 described above, for example. Here, when it is judged that it is winning (S102: YES), it proceeds to S103.

Then, at S103, the main CPU 41 transmits the display command to the graphic board 68, and the graphic board 68 which received that command displays the letters “BONUS GET!!” at the display screen 132, as shown in FIG. 20, for example, so as to display the fact that the accumulated payout is won. After that, when S104 is executed, the payment of the accumulated payout is made. More specifically, values as much as the number of coins corresponding to the payout difference which is added and stored in the RAM 43 by S72 described above are added and stored as the credits in the RAM 43. At this point, the main CPU 41 transmits the display command to the graphic board 68, and the graphic board 68 which received that command changes the credit amount in the credit amount display area 132a on an upper right corner of the display screen 132. After that, when S105 is executed, the main CPU 41 resets the payout difference stored in the RAM 43 to “0”.

After that, including the case where it is judged that a card of a prescribed symbol is not displayed at the display screen 132 (S100: NO) or where it is judged that it is not winning (S102: NO), it returns to the gaming machine processing of FIG. 13, and the gaming machine processing of FIG. 13 is carried out repeatedly, as described above.

Even in this case, the additional game for awarding the payout difference described above can be carried out without obstructing a smooth proceeding of the draw poker, so that it is possible to increase interests of players with respect to the draw poker.

Also, the exemplary case of application to the poker game machine has been described in the present embodiment, but it is also possible to consider the application to a pachi-slot machine or the like that is used only in Japan. Note that, in the case of the application to a pachi-slot machine or the like that is used only in Japan, it can be configured such that both a child combination and a big combination can be won simultaneously, and when a child combination is won while the simultaneous winning of a child combination and a big combination is carried over, the carry over of the winning of a big combination as well as a child combination is reset while at the same time the payout difference between a big combination and a child combination is accumulated, and the accumulated payout difference will be paid when a prescribed condition is satisfied.

The present invention is applicable to the payout technique in the card game to be executed by a gaming machine.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A gaming machine comprising:
a display device operable to display cards selected from a card deck;
a card lottery device operable to execute a card lottery providing a lottery result capable of including two or more combinations;
a processor operable to select destined cards from the card deck in response to the lottery result and an operation by a player, and to cause the display device to eventually display the destined cards;
a payout awarding device operable to award a payout if the destined cards include any of specific combinations, the payout being correspondent to said any of the specific combinations;
a gaming machine value accumulation device operable to automatically accumulate a difference between a highest payout corresponding to an optimum combination and the payout awarded by the payout awarding device as gaming values when said any of the specific combinations is different from the optimum combination corresponding to the highest payout among two or more combinations that can be realized by the lottery result and the operation of the player; and
a gaming value payout device operable to pay the gaming values accumulated by the gaming value accumulation device.

2. The gaming machine of claim 1, wherein the gaming value payout device pays the gaming values if the destined cards include a special combination.

3. The gaming machine of claim 1, wherein the gaming value payout device pays the gaming values if the destined cards include specific cards.

4. The gaming machine of claim 1, further comprising:
a gaming value lottery device operable to carry out a lottery regarding whether to cause the gaming value payout device to pay the gaming values or not.

5. A gaming machine comprising:
a display device operable to display cards selected from a card deck; and
a processor operable to execute a card lottery providing a lottery result capable of including two or more combinations, select destined cards from the card deck in response to the lottery result and an operation by a player, cause the display device to eventually display the destined cards, award a payout if the destined cards include any of specific combinations, the payout being correspondent to said any of the specific combinations, automatically accumulate a difference between a highest payout corresponding to an optimum combination and the payout awarded as gaming values when said any of the specific combinations is different from the optimum combination corresponding to the highest payout among two or more combinations that can be realized by the lottery result and the operation of the player, and carry out a payment of the accumulated gaming values.

6. The gaming machine of claim 5, wherein the processor carries out the payment if the destined cards include a special combination.

7. The gaming machine of claim 5, wherein the processor carries out the payment if the destined cards include specific cards.

8. The gaming machine of claim 5, wherein the processor is further operable to carry out a lottery regarding whether to carry out the payout or not.

9. A gaming machine comprising:
a display adapted to display a plurality of cards selected from a card deck;
an input device configured to receive an input of selection of cards from a player; and
a processor operable to execute a card lottery of first cards to be displayed in the display and second cards to be re-displayed in the display in response to the input of the selection by the player by means of the input device, judge whether a first specific combination is realized by the first cards and the second cards to which the card lottery is executed, cause the display to display the first cards, cause the display to display a final hand by replacing the first cards with the second cards according to the input of the selection by the player, judge whether a second specific combination is realized by the final hand displayed in the display, pay out a payout correspondent to the second specific combination if the second specific combination is realized, accumulate a difference between the payout correspondent to the second specific combination and a payout correspondent to the first specific combination if the payout correspondent to the second specific combination is greater than the payout correspondent to the first specific combination, and payout the accumulated payout if a specific condition is realized, the processor being in communication with the display and the input device.

10. The gaming machine of claim 9, wherein the specific condition includes a condition in which the final hand includes a special combination.

11. The gaming machine of claim 9, wherein the specific condition includes a condition in which the final hand includes specific cards.

12. The gaming machine of claim 9, wherein the specific condition includes a determination by a lottery executed by the processor.
